(19) United States
(12) Patent Application Publication
(10) Pub. No.: US 2012/0290217 A1
(43) Pub. Date: Nov. 15, 2012

(54) SYSTEM AND METHOD FOR TRACKING RECORDING AND ANALYZING SPATIAL ACTIVITY OF A SUBJECT FOR MEDICAL AND OTHER APPLICATIONS

(76) Inventors: Noam Shoval, Kfar Adomim (IL); Michal Isaacson, Kfar Adomim (IL); Yair Brazilay, Jerusalem (IL)

(21) Appl. No.: 13/389,594

(22) PCT Filed: Aug. 9, 2010
(86) PCT No.: PCT/IB2010/053595

§ 371 Date: Jun. 18, 2012

Related U.S. Application Data
(60) Provisional application No. 61/232,437, filed on Aug. 9, 2009.

(51) Int. Cl. G06F 19/00; G01C 22/00

(52) U.S. Cl. 702/19; 702/150

(57) ABSTRACT

The present invention is a method, circuit and system for characterizing one or more aspects of a subject's physical condition based on data generated by a localization device, such as an accelerometer, an inertial navigation system (INS), a global positioning system (GPS) unit or any combination thereof, carried by or affixed to the subject.

### FIELD OF THE INVENTION

Aspects of the present invention generally relate to human monitoring. More specifically, aspects of the present invention relate to a systems and methods for tracking, recording and analyzing a subject's daily spatial activity for medical and other applications.

### BACKGROUND

There are numerous situations where it is desirable to record and characterize the daily activity (e.g. walking, running, sitting, etc.) of a subject, for example a patient or person under professional/medical observation.

Data relating to a subject's daily activity is one of the best indications of a subject's actual physical condition and abilities at a certain time and so can be invaluable in the diagnosis and treatment of numerous conditions, and in the general monitoring and maintenance of a subject's health and wellbeing. Moreover, access to data relating to a subject's daily activity allows for better supervision of a subject's adherence to instructions or a treatment plan.

Tracking a subject's daily activity, however, is a complex task even when the subject is entirely within a controlled environment such as a hospital or rehabilitation facility. The level of complexity associated with tracking and characterizing activity of a subject in an uncontrolled environment is considerably greater and, under current methods, highly inaccurate.

Currently, the primary source for collecting data relating to a subject's daily activity, is the subject himself/herself. Subjects, however, do not have the tools to accurately measure their spatial activity. They also tend to be influenced, consciously or unconsciously, by emotional factors and personal sensitivities. Furthermore, subjects are bound to overlook, forget or remember incorrectly some of their activities and sometimes they just lie outright. The result is a rough estimation which is largely subjective. Moreover, as the data received from each subject differs and requires interpretation, normalized universal standards are hard to establish.

Therefore, an objective, accurate and reliable system and method for collecting and analyzing data relating to a subject's daily spatial activity would be desirable.

### SUMMARY OF THE INVENTION

The present invention is a method, circuit and system for characterizing one or more aspects of a subject's condition based on data generated by a localization device, such as an accelerometer, an inertial navigation system (INS), a global positioning system (GPS) unit, or any combination thereof, carried by or affixed to the subject. Aspects of the subject's condition, including but not limited to, the subjects daily level of activity, the subjects mobility, the subject's biometric measurements during different activities, the subject's ability to remain seated, the frequency of the subject's visits to the bathroom, the subject's motivation/moral and other characteristics of the subject's condition, may be derived from raw positioning data generated by the localization device. The raw data may be intermittently or substantially continuously transmitted to a data processing unit or server which may analyze the raw data to obtain different parameters relating to the subject's activity and aggregate the results of the analysis into known standardized indexes.

According to some embodiments of the present invention a subject may carry throughout the day, a localization unit, which may be comprised of: (i) an accelerometer, (ii) an inertial navigation system (INS), (iii) a global positioning system (GPS) unit; (iv) a communication module, such as a cellular modem, Bluetooth module, RFID or any other data communication module known today or to be devised in the future, (v) a storage device, and/or (vi) any combination thereof. According to further embodiments of the present invention, there may be provided one or more biometric sensors functionally associated with the localization device. The biometric sensor(s) may detect biometric parameters of the subject throughout the day. According to yet further embodiments of the present invention, there may be provided one or more gait sensors functionally associated with the localization device and adapted to detect gait parameters of the subject throughout the day (e.g. cadence, stride length, single and double limb support, etc.).

According to some embodiments of the present invention, the localization unit may detect the subject's position throughout the day and transmit data relating to the subjects locations, movement and/or biometric measurements to a data processing unit or server which may store the data on a storage device. According to further embodiments of the present invention, the data may be stored on a storage device functionally associated with the localization unit and periodically downloaded to a data processing unit or server which may store the downloaded data on a storage device. According to yet further embodiments of the present invention, the data may be transmitted or otherwise transferred, substantially continuously or periodically, to a base station or other intermediary which may subsequently transfer the data to a data processing unit or server.

According to some embodiments of the present invention, a data processing unit or server may analyze the stored data to determine a subject's spatial activity during specified time frames. This analysis may include; (i) categorizing each position detected by the localization unit as a location where the subject was stationary or in motion; (ii) associating each location detected by the localization unit with a type of activity, i.e. walking, sitting, etc.; (iii) calculating parameters relevant to the specific activity determined, i.e. speed of movement, duration of the activity, number and duration of stops, etc.; (iv) collecting and integrating related topographical, environmental and personal parameters; (v) correlating biometric data with a subjects spatial activities; and (vi) aggregating the collected data and accordingly characterizing a subject's condition and/or daily activity based on standardized indexes, such as medical indexes.

This analysis may begin by characterizing different points the subject was located at during the specific time frame as being within “nodes” or along “tracks”. Wherein a “node” may be a location where the subject remained for a certain period of time, whereas a “track” may be a location the subject only passed through. In other words, a “node” may be a location the subject visited or was stationary, whereas a “track” may be a location where the subject was in motion. The determination whether a point is within a node or along a track may depend on a series of criteria including, the amount of time spent at the point or within a certain radius of the point, the pace of movement between points and so on.

According to some embodiments of the present invention, “clouds” of points (multiple points detected within a small radius), which may have been detected as different points as a result of inaccuracies of the localization unit while it is still, may be considered one point for the purpose of analyzing a subject's daily spatial activity.

According to further embodiments of the present invention, a data processing unit or server may calculate the speed at which the subject moved over a “track” and characterize the movement accordingly, whereas one speed may be walking, one running, one riding a bicycle another driving/riding-in a car and so on.

Identified nodes and tracks may be assigned numbers for later comparison and to identify subject's routines.

According to further embodiments of the present invention a data processing unit or server may collect topographical, environmental and other related parameters relating to the points, tracks and nodes detected by the localization unit, e.g. incline, weather conditions, terrain, personal data, etc. These parameters may be used to further characterize the subject's spatial activity. These parameters may also be used to characterize nodes and the activity conducted therein. For example, the data processing unit or server may recognize one node as “home”, one as “work” another as the “gym” and so on. Thus, the data processing unit or server may associate the subject's collocation within a certain node as including certain physical activities.

According to further embodiments of the present invention a data processing unit or server may correlate biometric parameters and gait parameters collected by the biometric sensors and the gait sensors with the points, tracks and nodes detected by the localization unit, e.g. pulse, blood pressure, glucose levels, breathing patterns, oxygen consumption, etc. These parameters may be used to further characterize a subject's spatial activity during certain times and/or in certain locations and/or to further characterize aspects of the subject's condition. For example, these parameters may be used to determine whether a subject's improvement in one aspect of his/her condition has affected other aspects. These parameters may also help in identifying malingers (i.e. subjects feigning illness) and false identity (i.e. persons attempting to impersonate the subject by carrying the localization device in their stead). These parameters may also serve to warn of unwanted side effects of a treatment.

According to yet further embodiments of the present invention, a data processing unit or server may aggregate the data collected and analyzed regarding a specific subject. The aggregated data may be used to measure the spatial activity of the subject, i.e. distance walked, speed, difficulty, number of stops, etc. The aggregated data may also serve to characterize the subject's condition and/or daily activity according to different indexes, including medical indexes, such as the claudication index (see FIG. 12).

According to yet further embodiments of the present invention, the aggregated data may also serve to monitor changes in the subject's spatial movement over periods of time, for example during recovery from an operation. The aggregated data may also be compared to other subjects or general norms.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1: is an illustration of an exemplary system for tracking, recording and analyzing a subject's daily Spatial Activity for medical and other applications, in accordance with some embodiments of the present invention.

FIG. 2A: is an illustration of an exemplary system for tracking, recording and analyzing a subject's daily Spatial Activity for medical and other applications, exemplifying some embodiments of the present invention wherein the positioning data is transferred via cellular communication.

FIG. 2B: is an illustration of an exemplary system for tracking, recording and analyzing a subject's daily Spatial Activity for medical and other applications, exemplifying some embodiments of the present invention wherein positioning data is obtained from a cellular operator.

FIG. 2C: is an illustration of an exemplary system for tracking, recording and analyzing a subject's daily Spatial Activity for medical and other applications, exemplifying some embodiments of the present invention wherein the positioning data is transferred via base stations.

FIG. 3-11B: are exemplary illustrations and graphs of exemplary parameters derived by a system for tracking, recording and analyzing a subject's daily Spatial Activity for medical and other applications and some of the possible presentations of such parameters, all in accordance with some embodiments of the present invention.

FIG. 12: is an exemplary graph of exemplary parameters and an exemplary medical index that may be generated in accordance with some embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

It should be understood that the accompanying drawings are presented solely to elucidate the following detailed description, are therefore, exemplary in nature and do not include all the possible permutations of the present invention.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices. The term server may refer to a single server or to a functionally associated cluster of servers.

Embodiments of the present invention may include apparatuses for performing the operations herein. This apparatus may be specially constructed for the desired purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

The processes and displays presented herein are not inherently related to any particular computer or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the inventions as described herein.

Terms in this application relating to distributed data networking, such as send or receive, may be interpreted in reference to Internet protocol suite, which is a set of communications protocols that implement the protocol stack on which the Internet and most commercial networks run. It has also been referred to as the TCP/IP protocol suite, which is named after two of the most important protocols in it: the Transmission Control Protocol (TCP) and the Internet Protocol (IP), which were also the first two networking protocols defined. Today's IP networking represents a synthesis of two developments that began in the 1970s, namely LANs (Local Area Networks) and the Internet, both of which have revolutionized computing.

The Internet Protocol suite—like many protocol suites—can be viewed as a set of layers. Each layer solves a set of problems involving the transmission of data, and provides a well-defined service to the upper layer protocols based on using services from some lower layers. Upper layers are logically closer to the user and deal with more abstract data, relying on lower layer protocols to translate data into forms that can eventually be physically transmitted. The TCP/IP reference model consists of four layers.

Layers in the Internet Protocol Suite

The IP suite uses encapsulation to provide abstraction of protocols and services. Generally a protocol at a higher level uses a protocol at a lower level to help accomplish its aims. The Internet protocol stack has never been altered, by the IETF, from the four layers defined in RFC 1122. The IETF makes no effort to follow the seven-layer OSI model and does not refer to it in standards-track protocol specifications and other architectural documents.

| | |
|---|---|
| 4. Application | DNS, TFTP, TLS/SSL, FTP, Gopher, HTTP, IMAP, |
| | IRC, NNTP, POP3, SIP, SMTP, SNMP, SSH, |
| | TELNET, ECHO, RTP, PNRP, rlogin, ENRP |
| | Routing protocols like BGP, which for a variety of |
| | reasons run over TCP, may also be considered |
| | part of the application or network layer. |
| 3. Transport | TCP, UDP, DCCP, SCTP, IL, RUDP |
| 2. Internet | Routing protocols like OSPF, which run over IP, are |
| | also to be considered part of the network layer, |
| | as they provide path selection. ICMP and IGMP |
| | run over IP and are considered part of the network |
| | layer, as they provide control information. |
| | IP (IPv4, IPv6) |
| | ARP and RARP operate underneath IP but above the |
| | link layer so they belong somewhere in between. |
| 1. Network access | Ethernet, Wi-Fi, token ring, PPP, SLIP, FDDI, |
| | ATM, Frame Relay, SMDS |

It should be understood that any topology, technology and/or standard for computer networking (e.g. mesh networks, infiniband connections, RDMA, etc.), known today or to be devised in the future, may be applicable to the present invention.

The present invention is a method, circuit and system for characterizing one or more aspects of a subject's condition based on data generated by a localization device, such as an accelerometer, an inertial navigation system (INS), a global positioning system (GPS) unit or any combination thereof, carried by or affixed to the subject. Aspects of the subject's condition, including but not limited to, the subjects daily level of activity, the subjects mobility, the subject's biometric measurements during different activities, the subject's ability to remain seated, the frequency of the subject's visits to the bathroom, the subject's motivation/moral and other characteristics of the subject's condition, may be derived from raw positioning data generated by the localization device. The raw data may be intermittently or substantially continuously transmitted to a data processing unit or server which may analyze the raw data to obtain different parameters relating to the subject's activity and aggregate the results of the analysis into known standardized indexes.

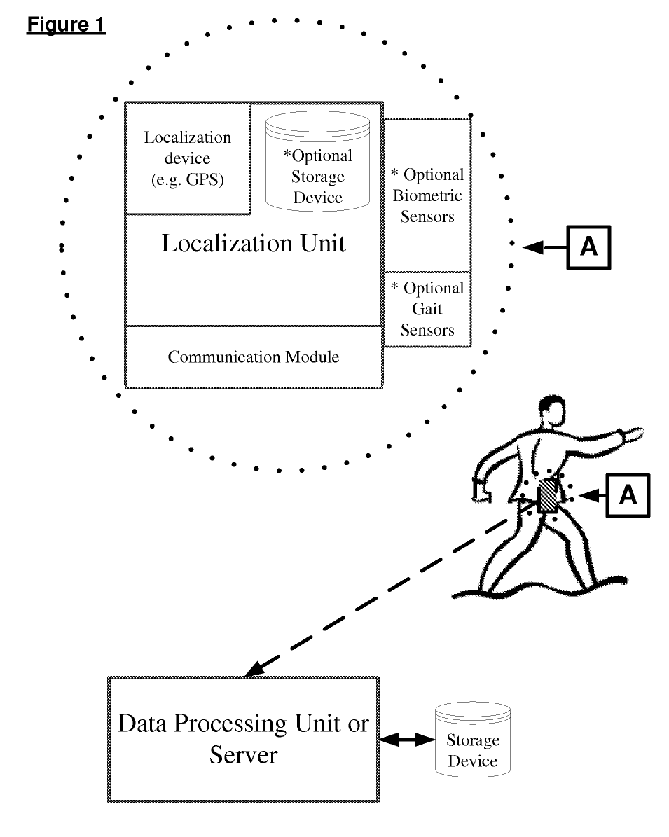

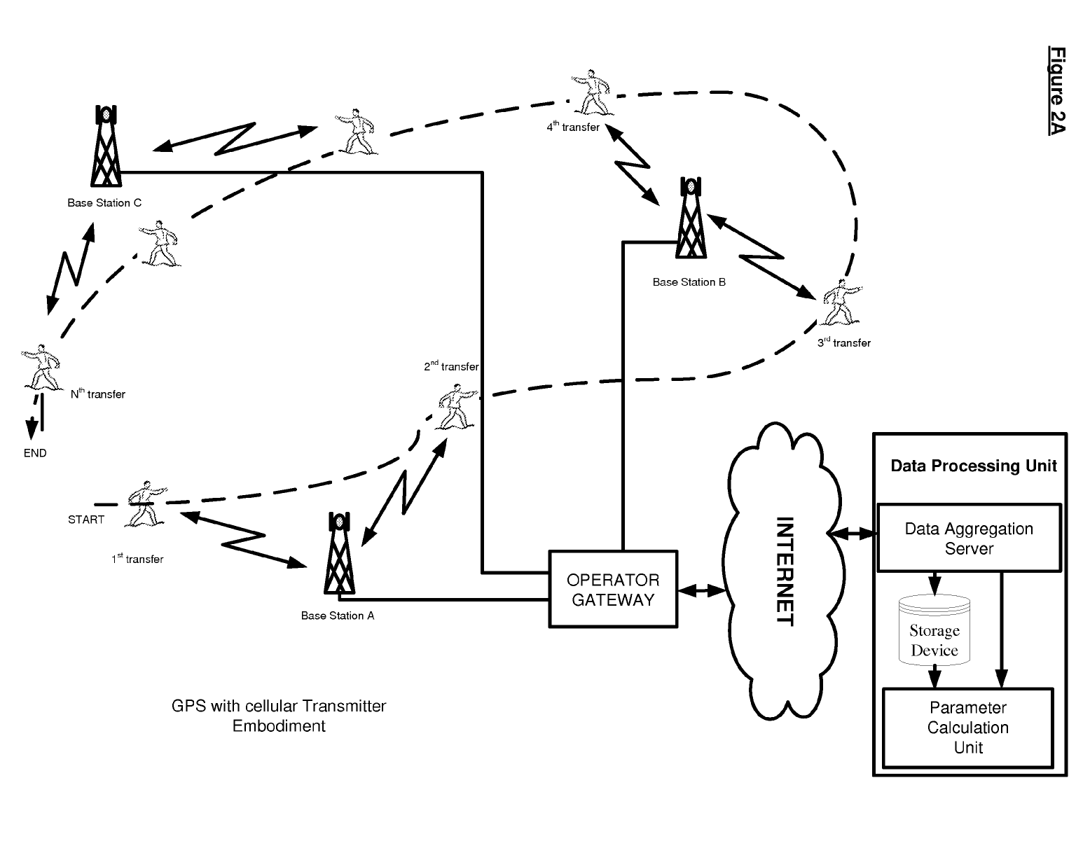

According to some embodiments of the present invention a subject may carry throughout the day, a localization unit [see FIG. 1], which may be comprised of: (i) an accelerometer, (ii) an inertial navigation system (INS), (iii) a global positioning system (GPS) unit; (iv) a communication module, such as a cellular modem, Bluetooth module, RFID or any other data communication module known today or to be devised in the future, (v) a storage device, and/or (vi) any combination thereof. According to further embodiments of the present invention, there may be provided one or more biometric sensors functionally associated with the localization device [see FIG. 1]. The biometric sensor(s) may detect biometric parameters of the subject throughout the day. According to yet further embodiments of the present invention, there may be provided one or more gait sensors [see FIG. 1] functionally associated with the localization device and adapted to detect gait parameters of the subject throughout the day (e.g. cadence, stride length, single and double limb support, etc.).

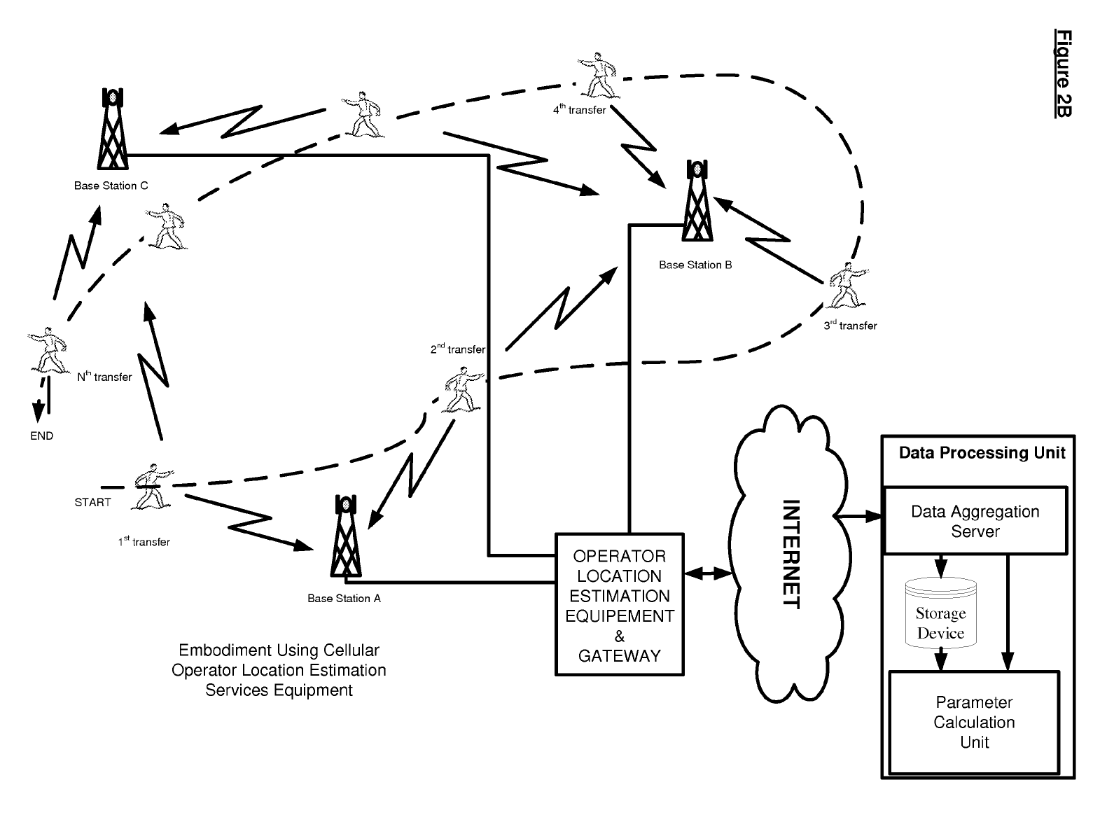

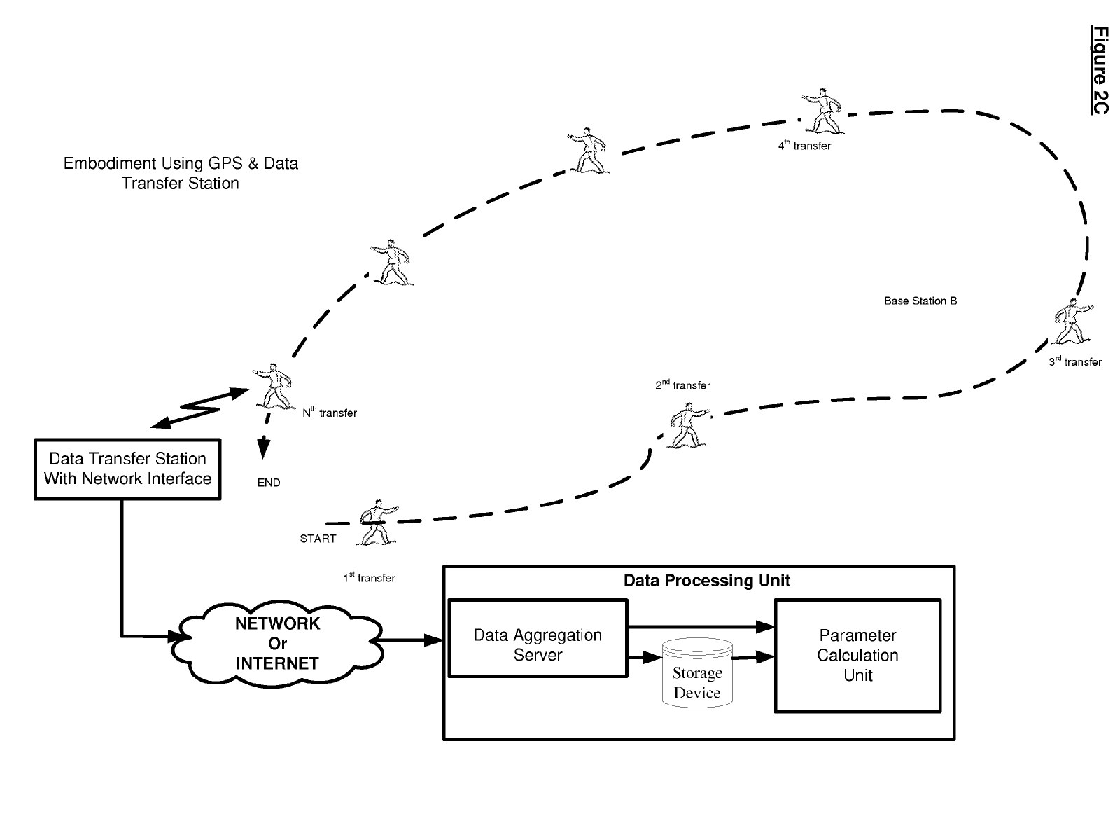

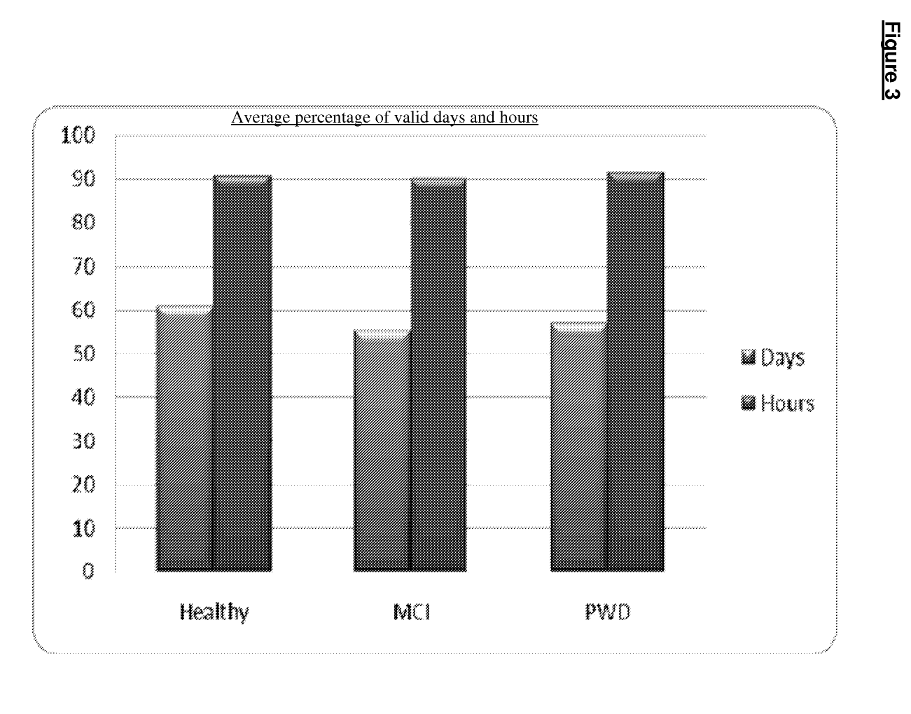

According to some embodiments of the present invention, the localization unit may detect the subject's position throughout the day and transmit data relating to the subjects locations, movement and/or biometric measurements to a data processing unit or server which may store the data on a storage device [see FIG. 1]. According to further embodiments of the present invention, the data may be stored on a first storage device functionally associated with the localization unit and periodically downloaded to a data processing unit or server which may store the downloaded data on a second storage device, functionally associated with the data processing unit or server. Said first storage device may be carried by the subject, possibly physically contained within or adjacent to the localization unit, or may be a physically separate device, possibly kept in the subject's home, or both. According to yet further embodiments of the present invention, the data may be transmitted or otherwise transferred, substantially continuously or periodically, to a base station or other intermediary which may subsequently transfer the data to a data processing unit or server [see FIG. 2C]. according to yet further embodiments of the present invention, data may be transferred to the data processing unit, via a third party, such as a cellular operator [see FIG. 2A].

According to some embodiments of the present invention, a data processing unit or server may analyze the stored data to determine a subject's spatial activity during specified time frames. This analysis may include; (i) categorizing each position detected by the localization unit as a location where the subject was stationary or in motion; (ii) associating each location detected by the localization unit with a type of activity, i.e. walking, sitting, etc.; (iii) calculating parameters relevant to the specific activity determined, i.e. speed of movement, duration of the activity, number and duration of stops, etc.; (iv) collecting and integrating related topographical, environmental and personal parameters; (v) correlating biometric data with a subjects spatial activities; and (vi) aggregating the collected data and accordingly characterizing a subject's condition and/or daily activity based on standardized indexes, such as medical indexes. According to some further embodiments of the present invention, the processing unit may include a data aggregation server or database and a parameter calculating/estimating/determining unit [see FIGS. 2A-2C].

This analysis may begin by characterizing different points the subject was located at during the specific time frame as being within “nodes” or along “tracks”. Wherein a “node” may be a location where the subject remained for a certain period of time, whereas a “track” may be a location the subject only passed through. In other words, a “node” may be a location where the subject visited or was stationary, whereas a “track” may be a location where the subject was in motion. The determination whether a point is within a node or along a track may depend on a series of criteria including, the amount of time spent at the point or within a certain radius of the point, the pace of movement between points and so on. The determination whether a point is within a node or along a track may be performed with the following algorithm:
Input points {x,y and time}
Sort points by time.
i=1
for each point
if distance [point(k+i)−point(k)]<minimum distance then: i=i+1
else: if time(k+i)−time(k)>minimum duration & i>1 then: code points k till k+i as a node
else: i=1
merge nodes that are closer than Minimum Distance Between Nodes

According to some embodiments of the present invention, “clouds” of points (multiple points detected within a small radius), which may have been detected as different points as a result of inaccuracies of the localization unit while it is still, may be considered one point for the purpose of analyzing a subject's daily spatial activity.

According to further embodiments of the present invention, a data processing unit or server may calculate the speed at which the subject moved over a “track” and characterize the movement accordingly, whereas one speed may be walking, one running, one riding a bicycle another driving/riding-in a car and so on.

Identified nodes and tracks may be assigned numbers for later comparison and to identify subject's routines.

According to further embodiments of the present invention a data processing unit or server may collect topographical, environmental and other related parameters relating to the points, tracks and nodes detected by the localization unit, e.g. incline, weather conditions, terrain, personal data, etc. These parameters may be used to further characterize the subject's spatial activity. These parameters may also be used to characterize nodes and the activity conducted therein. For example, the data processing unit or server may recognize one node as “home”, one as “work” another as the “gym” and so on. Thus, the data processing unit or server may associate the subject's collocation within a certain node as including certain physical activities. Thus, the data processing unit or server may also determine how often a subject visited the restroom, the hours and quality of his/her sleep and so on.

According to further embodiments of the present invention, parameters of a subject's spatial activity may be used to determine a subject's patterns of spatial activity. A subject's patterns of spatial activity may be used to further characterize a subject's physical and psychological condition. For example, parameters indicating patterns of: which locations the subject goes to regularly as opposed to randomly, whether a subject goes only to mandatory activities or also to voluntary activities, whether the subject attends social functions, and so on, may be used to characterize the subject's psychological condition, the amount and frequency of pain he/she is suffering, his/her reaction to changes in his/her condition or treatment, and so on.

According to further embodiments of the present invention a data processing unit or server may correlate biometric parameters and gait parameters collected by the biometric sensors and the gait sensors with the points, tracks and nodes detected by the localization unit, e.g. pulse, blood pressure, glucose levels, breathing patterns, oxygen consumption, etc. These parameters may be used to further characterize a subject's spatial activity during certain times and/or in certain locations and/or to further characterize aspects of the subject's condition. For example, these parameters may be used to determine whether a subject's improvement in one aspect of his/her condition has affected other aspects, such as whether a patient's heart condition has improved as a result of improvement in his/her mobility. These parameters may also help in identifying malingers (i.e. subjects feigning illness) and false identity (i.e. persons attempting to impersonate the subject by carrying the localization device in their stead). These parameters may also serve to warn/alert of unwanted, or desired, side effects of a treatment (for example, a subject's orthopedic treatment, such as physiotherapy, may affect the subject's cardiovascular condition, positively or negatively. These affects may be detected by analyzing biometric data collected by the biometric sensors).

According to yet further embodiments of the present invention, a data processing unit or server may aggregate the data collected and analyzed regarding a specific subject. The aggregated data may be used to measure the spatial activity of the subject, i.e. distance walked, speed, difficulty, number of stops, etc. The aggregated data may also serve to characterize the subject's condition and/or daily activity according to different indexes, including medical indexes, such as the claudication index.

According to some embodiments of the present invention, spatial data collected, both in its raw form and/or after analysis, may be used for clinical evaluations, including medical diagnosis, monitoring of recovering patients, monitoring of patients before and/or after medical procedures and/or treatment, monitoring of high risk subject's (e.g. persons who have a family history of heart disease), evaluation of the effectiveness of a treatment and/or any other medical evaluation. For example, the data may be used:
a. to diagnose and/or monitor patients with orthopedic conditions (before, during and after treatment and/or surgery);
b. to diagnose and/or monitor patients with cardiovascular conditions (before, during and after treatment and/or surgery);
c. to diagnose and/or monitor patients with joint pathologies, such as rheumatoid arthritis or osteoarthritis;
d. to diagnose and/or monitor patients with neurodegenerative conditions, such as multiple sclerosis, Alzheimer's disease, Parkinson's and ALS; and/or
e. to diagnose and/or monitor patients with other conditions (before, during and after treatment and/or surgery).

According to yet further embodiments of the present invention, the aggregated data may also serve to monitor changes in the subject's spatial movement over periods of time, for example during recovery from an operation. This may also serve to warn of deterioration or a sudden worsening of a patient's condition. For example, if a patient recovering from heart surgery starts walking more slowly or going to the bathroom more often, these could be early signs of heart failure and may indicate a need for interventive surgery. The aggregated data may also be compared to other subjects or general norms.

According to yet further embodiments of the present invention, the above described system and method may be used to provide data for research, including medical research. For example, by providing data and analysis of a patient's spatial activity after experimental treatment, or by providing supplemental data regarding spatial activity of a patient being otherwise monitored.

According to yet further embodiments of the present invention, positioning data relating to the subject may be received from a cellular operator which has the ability to detect positioning information relating to cellular devices communicating with it [see FIG. 2B].

It should be understood by one of skill in the art that some of the functions described as being performed by a specific component of the system may be performed by a different component of the system in other embodiments of this invention.

The present invention can be practiced by employing conventional tools, methodology and components. Accordingly, the details of such tools, component and methodology are not set forth herein in detail. In the previous descriptions, numerous specific details are set forth, in order to provide a thorough understanding of the present invention. It should be recognized, however, that the present invention might be practiced without resorting to the details specifically set forth.

Only exemplary embodiments of the present invention and but a few examples of its versatility are shown and described in the present disclosure. It is to be understood that the present invention is capable of use in various other combinations and environments and is capable of changes or modifications within the scope of the inventive concept as expressed herein.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

### EXEMPLARY EMBODIMENTS

The following are descriptions of two exemplary implementations of the present invention. These following specific exemplary embodiments of the present invention are presented to further elucidate the present invention and to exemplify its principles and their many possible implementations. As such, the following examples should not be understood to encompass the full scope of the present invention in any way. It should be clear to anyone of ordinary skill in the art that many other implementations of the present invention are possible.

### Exemplary Implementation #1

The following text describes an experiment, conducted by one of the inventors of the present invention, in accordance with some embodiments of the present invention:

### Methods

### Data Collection

The GPS tracking kit (Manufactured by HomeFree Wireless TelehomeCare Solutions, Tel-Aviv, Israel) consists of three main elements: 1) a portable unit that is carried by the subject and contains a GPS receiver, GSM modem and an RF receiver; 2) a wristwatch, which includes an RF transmitter and additional sensors including a body sensor that detects whether the transmitter/watch is being worn on a person's body; and 3) a stationary home unit that repeats the RF signal and allows the participant to walk freely around the house.

The waterproof RF transmitter/watch allows the researchers to know whether participants are complying with the research participation guidelines and whether they are carrying the GPS device at a given moment. If the RF transmitter is not in contact with the body, the system will issue a notification. If the watch is worn on the hand, but is further than ten meters from the GPS receiver (at home this maximum distance is 70 meters because of the home monitoring unit) then a notification will be issued again. These notifications allow the researchers to determine whether the research subject is participating at a satisfactory level and assures that the collected data represents the entire spatial activity away from home.

The GPS receiver is programmed to obtain locations every 10 seconds when the tracked person is outside the home. The data collected is sent by GPRS to the project's server. This enables monitoring the tracking kits in real-time (battery level, geographical location, participant's compliance level etc.).

The transmitted data was analyzed by semiautomatic processes with human quality control. This was based on a framework developed for the SenTra project (Shoval el al. 2008). The analysis process is based on dividing the collected points to points that describe movement and points that were collected when the participant was not in motion. The next step was to use the points describing motion to calculate walking distances, number of daily out of home walking events, average walking speed, and time spent in a vehicle, number of trips made by car, and distances of the car trips. The algorithm that was implemented enables differentiation between walking patients and patients driving a car, even when driving at a very slow pace, i.e. a traffic jam. A claudication index is calculated as the maximum distance walked before the patient needed to stop and rest. All patients completed a questionnaire at the end of each tracking period, expressing their thoughts and feelings about this method of outcome measurement.

The study was approved by the internal research board and the internal ethics committee (Helsinki committee number: 0049-08-HMO). The NIH number of this research project is: NCT00641823.

### The Patients

Two patients were monitored for several weeks around the time of their spinal surgery using a real time tracking system. Patient 1 is 56-year old woman who underwent her third revision spine surgery. Prior surgeries included discectomy and two decompression surgeries. In the past two years the patient presented with incapacitating low back pain, referred pain to her right lower extremity. Imaging studies (MRI) revealed advanced degenerative disease at L4-5 and L5-S1 (severe) and translational instability in L4-5. She underwent a posterior spinal fusion of L5-S1, and dynamic stabilization of L4-5. Four days later she was discharged to her home which is located in a rural community.

Patient 2 is a 74-year old woman who suffered from radiating pain to her right lower extremity, preventing normal mobility and severely affecting her daily activities. She underwent a clinical, radiographic and injection work-up to differentiate between her right hip and her lumbar spine as the source of her pain. She was finally diagnosed as suffering from right L4 radiculopathy due to a foraminal herniation of the L4-5 disk level compressing the right L4 root. Non-operative measures and selective nerve root blocks failed to improve her pain or function, therefore endoscopic foraminoplasty and discectomy was performed. Post operatively the radicular pain subsided. However, outdoor activities evoked right hip pain. She was subsequently diagnosis with avascular necrosis of the right femoral head and underwent a right total hip replacement.

### Results

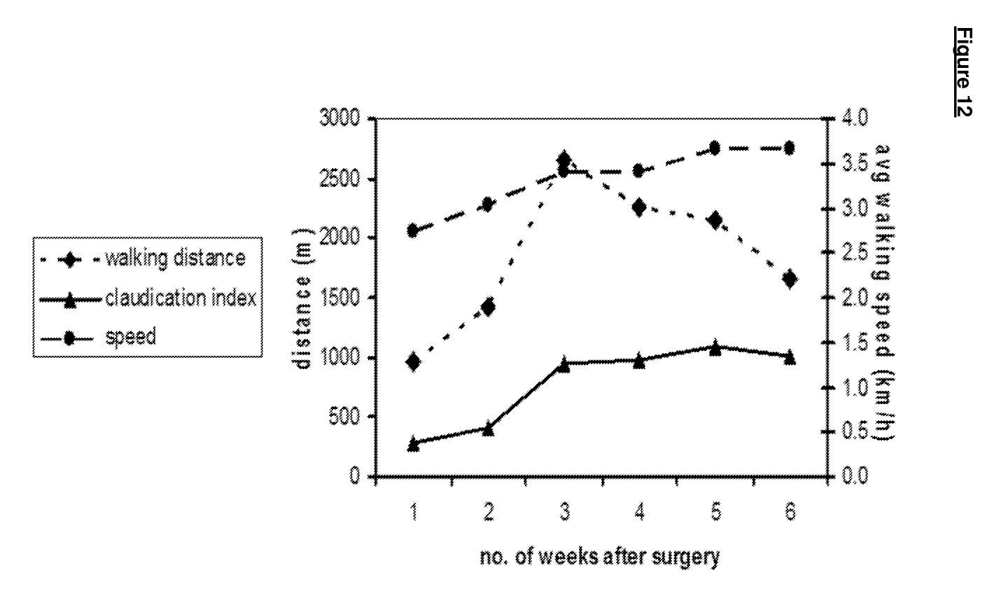

Patient Number 1 was tracked for 40 days following discharge from hospital. Her overall level of participation was very high; she had 35 valid days of participation (i.e. days with complete (24 hours) data). Average walking distance per week, average speed per week, and the average claudication index are presented in table 1 and FIG. 12. The data show that the patient's ability to walk improved from the surgery to the end of the tracking period. This improvement is reflected in a faster walking speed (from 2.74 to 3.66 km/hour) and a higher claudication index result (from 280 meters to >1000 meters). A reduction in the walking distance starting in the third week reflects an increase in motor vehicle trips, due mainly to the patient's return to work. The improvement in her mobility was also supported by her self report of less pain and improved function.

TABLE 1
Weekly statistics of walking and motorized tracks
of case number 1 [see also FIG. 1]

| | Wk 1 | Wk 2 | Wk 3 | Wk 4 | Wk 5 | Wk 6 |
|---|---|---|---|---|---|---|
| | (7)* | (7) | (6) | (6) | (7) | **(3) |
| Walking tracks | | | | | | |
| Avg. speed | 2.74 | 3.02 | 3.42 | 3.42 | 3.66 | 3.66 |
| (km/h) | | | | | | |
| Avg. walking | 966 | 1421 | 2646 | 2256 | 2148 | 1666 |
| distance | | | | | | |
| per day (m) | | | | | | |
| Avg. walking | 24 | 32 | 49 | 40 | 36 | 31 |
| duration per | | | | | | |
| day (min) | | | | | | |
| Claudication | 280 | 403 | 949 | 984 | 1093 | 1009 |
| index (m) | | | | | | |
| No. of tracks | 5.14 | 4.86 | 4.83 | 4.33 | 3.71 | 2.67 |
| Percent of time | 98 | 90 | 96 | 93 | 88 | 84 |
| spent at home | | | | | | |
| Motorized | | | | | | |
| tracks | | | | | | |
| Average no. of | 0.0 | 4.5 | 1.0 | 1.5 | 3.0 | 3.0 |
| car trips | | | | | | |
| Average | 0.0 | 37.2 | 0.0 | 5.0 | 11.8 | 41.8 |
| distance (km) | | | | | | |
| Average | 0.0 | 157.8 | 0.6 | 23.2 | 46.0 | 69.5 |
| duration (min) | | | | | | |

*Number of valid days is in brackets.
**Partial week - includes only 5 days

Patient Number 2 was tracked for 12 days prior to her surgery and 46 days following the procedure. A few days after she returned home, researchers noted that the patient hardly had any outdoor walking events. During the consultation she was asked to mobilize as tolerated and to increase her activities gradually. Her outdoor activity increased steadily over the next 2 weeks and then suddenly stopped. The tracking team contacted the patient and advised another consultation with her surgeon. The patient reported that the radicular pain had resolved, however she was experiencing a new pain in her right groin radiating to her right knee that prevented her from walking and disturbed her sleep. She underwent a repeat work-up and avascular necrosis (AVN) of the right hip was diagnosed. The patient underwent a right total hip replacement and is in the early recovery period. The patient's preoperative, immediate post-operative and late post-operative tracking results are presented in table 2. Forty seven out of the 58 days in which the patient was monitored were noted as valid. Most of the patients' outdoor mobilization was made by motor vehicles prior to surgery and after surgery.

TABLE 2
Weekly statistics of walking and motorized tracks of case number 2

| | Wk −1 | Wk 0 | Wk 1 | Wk 2 | Wk 3 | Wk 4 | Wk 5 | Wk 6 |
|---|---|---|---|---|---|---|---|---|
| | (5)* | (7) | (7) | (6) | (6) | (6) | (4) | (6) |
| Walking | | | | | | | | |
| tracks | | | | | | | | |
| Avg. speed | | 2.7 | 2.5 | | 3.6 | 2.2 | | 2.6 |
| (km/h) | | | | | | | | |
| Avg. | 0.0 | 53.6 | 11.4 | 0.0 | 79.8 | 74.5 | 0.0 | 101.2 |
| walking | | | | | | | | |
| distance | | | | | | | | |
| per Day | | | | | | | | |
| (m) | | | | | | | | |
| Avg. | 0.0 | 1.3 | 0.3 | 0.0 | 1.7 | 2.0 | 0.0 | 2.3 |
| walking | | | | | | | | |
| duration | | | | | | | | |
| per day | | | | | | | | |
| (min) | | | | | | | | |
| Claudication | 0.0 | 26.7 | 11.4 | 0.0 | 48.8 | 27.1 | 0.0 | 51.4 |
| index (m) | | | | | | | | |
| No. of tracks | 0.0 | 0.4 | 0.1 | 0.0 | 0.5 | 0.7 | 0.0 | 0.8 |
| Percent of | 84.5 | 73.6 | 99.5 | 87.7 | 90.0 | 88.7 | 96.2 | 87.6 |
| time spent | | | | | | | | |
| at home | | | | | | | | |
| Motorized | | | | | | | | |
| tracks | | | | | | | | |
| Average no. | 1.2 | 1.1 | 0.0 | 1.0 | 0.8 | 1.8 | 1.0 | 1.3 |
| of car trips | | | | | | | | |
| Average | 12.5 | 18.1 | 0.0 | 8.8 | 10.7 | 8.9 | 0.9 | 16.1 |
| distance | | | | | | | | |
| (km) | | | | | | | | |
| Average | 9.7 | 14.0 | 0.0 | 8.5 | 8.2 | 9.2 | 2.6 | 15.5 |
| duration | | | | | | | | |
| (min) | | | | | | | | |

*Number of valid days is in brackets.
† The monitoring continued for 2 more days in week 7 these days were non-valid

Both patients found the equipment acceptable and noncumbersome, and reported no difficulties. It seems that despite its relatively large size (400 grams) and the fact that the patients had to wear a specially designed watch with a RF component for the whole tracking period, the location kit did not disturb the patients. Patient 1 reported that it helped her in the recovery process from the operation, and that the knowledge that she was being tracked encouraged her to leave the house and mobilize.

### Discussion

Advanced tracking technology using GPS equipment was used to measure outcomes of spine surgery in two patients. This system allowed the collection of highly accurate spatial data including patient's compliance for a considerable period of time. It seems, even at this very early stage, that the information provided by this sophisticated technology may lead to comprehensive understanding of the recuperation of each patient following interventions affecting mobility (medical or surgical).

In addition, in the case of patient number 2, the tracking data alerted researchers to the fact that she was having difficulties mobilizing, leading to the diagnosis of an additional musculoskeletal problem.

These preliminary data support the feasibility of the rather complex data assessment approach used. Moreover, the use of such a tracking kit to monitor the outdoor time-space activities of patients after spine operations is feasible.

Information provided by this system offers an upgrade to the service given by treating physicians in two ways: (1) when norms and patterns of spatial activity in different pathologies are studied, the process of patient selection for medical, psychiatric and surgical interventions will be supported by objective data, and might improve outcomes of interventions (by omitting patients who are less likely to benefit from a procedure); and/or (2) In the post operative consultation, the pace of recovery and specific data relevant to the procedure will provide the treating physician an important tool that will allow for the recognition of the patients' “weaknesses” and will pinpoint where more efforts are needed—be it the need to encourage more activity or to identify spatial patterns suggestive of psychosocial problems (e.g., depression, staying all day at home, avoiding crowded areas) or suggestive if other pathologies affecting mobility (i.e. degenerative joint disease) leading to counseling and proper treatment.

Spatial data could be compared with some of the domains in the Oswestry questionnaire (Davidson & Keating, 2001; Fairbank & Pynsent, 2000); especially those dealing with out-door activities. Moreover, spatial information may indirectly relate to the patient's mental and social condition. For example, one patient with repeated visits to the local clinic greatly differs from another patient who repeatedly visits the mall, cinema, opera house or the local bar. A prospective comparison to commonly used questionnaires (i.e. SF-36), will shed more light on the effects of social, mental and economic issues on patient's outdoor behavior.

Another interesting and unexpected outcome was the assessment of the device by patient, who found the device helpful in their recovery period. Being monitored may contribute to motivation to adhere to the treatment plan regarding expected activities. The kit drew attention of neighbors and friends and made them feel important, interesting and attractive. These findings will trigger another study to evaluate the kit as an enhancer for better rehabilitation compared to common practice.

Patient's compliance is a concern when using such a kit for outcome assessment. The two patients in this pilot were highly motivated, however when dealing with patients with litigation or worker's compensation, compliance may become major issues. The RF watch can be locked to the patient's body, assuring that the information regarding compliance is accurate. Other possibilities include combinations of physiological data (i.e. heart rate, blood pressure etc) with the tracking data. This additional information can serve as an “identity card” and prevent incompliant patients from using family members or friends to “fool” the system, and will be able to differentiate between walking patients and patients being pushed in a wheel chair by care givers or family members. The authors believe that when enough data of norm and pathology would have been collected, patterns of malingering will be identified by analyzing outdoor spatial behavior. Spatial data may shed more light on processes like response shift and changes in patients' expectation when compared before and after treatment. In order to achieve these goals, studies will need to delineate the differences between patients' self assessment of function to objective function, as reflected in the GPS data and the change between patient's self assessment preoperatively compared to their assessment of the preoperative condition in the post operative phase.

Despite the limited data presented here, the potential of this type of data collection and analysis is clear. It should be emphasized that never before have such detailed and accurate data (GPS obtained) regarding outcomes of a procedure have been presented in the medical or in the geographic literature.

### Exemplary Implementation #2

The following text is an excerpt from an article [Shoval, Noam et al., “What can we team about the mobility of the elderly in the GPS era?” Journal of Transport Geography, Vol. 18, Issue 5 (September 2010), pgs. 603-612] recently published by two of the inventors of the present invention, describing an exemplary experiment conducted in accordance with some embodiments of the present invention:

In this paper we present a framework of analysis that we developed in order to deal with these challenges and opportunities presented by GPS-derived data. We first present preliminary findings regarding the out-of-home mobility of 49 elderly participants which included mildly demented, mildly cognitively impaired, and healthy men and women that were taken from the first phase of the Israeli component of the SenTra project. This project is a multi disciplinary Israeli-German project that studies the mobility of people with Alzheimer's disease and other related cognitive disorders using GPS and RFID technology combining researchers that specialize in: geography, social work, gerontology, psychology and medicine. The aim of the project is to use GPS data to learn about the out-of-home mobility of cognitively impaired as well as unimpaired older adults.

The participants' locations were obtained 24 hours a day at a sampling rate of 10 seconds for 28 consecutive days, using a location kit that combined global positioning system (GPS) with Radio Frequency Identification (RFID) technology. Next, we use the data from an individual participant to present our new method of data analysis with the new resolutions in time and space that the use of GPS obtained data enables us to achieve. Then, we use this analytic approach to present the results of aggregate data of the 49 participants. We conclude with an analysis of “tracks of mobility” as our unit of research. Using the approach presented in this paper, it thus becomes possible to make sense of the vast quantities of data obtained by continuous long-term GPS tracking of individuals.

Framework of Analysis for GPS Obtained Data

The data obtained by a GPS receiver could either be downloaded at certain times (for example at the end of a day) or, more conveniently for long periods of tracking, transferred by different communication protocols, such as Short Message Service (SMS) or General Packet Radio Service (GPRS) to a server. Once the data obtained by GPS receivers is successfully integrated into a Geographic Information System (GIS), the next step is analyzing the data. Generally speaking, two main types of analysis can be conducted. The first type of analysis examines the movement of the tracked person; the second type examines the allocation of time within space. In this article we focus on the first type of analysis. Both types of analysis can be conducted at different levels of aggregation. Table 1 delineates the possibilities of analysis at different aggregation levels and explains the meanings of the combination between analysis and level of aggregation.

TABLE 1
Analysis at different aggregation levels

| | Movement | Time Allocation |
|---|---|---|
| Individual | Visualizing of tracks, can help in | Can serve as a tool for |
| participant | refreshing the memory of | an in-depth interview. |
| | participants as to what they did | |
| | throughout the research period. | |
| Participants | Identifies routes that are preferred | Identifies patterns in |
| grouped | by people in the analyzed group; | time-spending within |
| using a | identifies areas that people | the group and between |
| common | wander through vs. areas of | different groups. |
| criterion | functional movement. | |
| such as | | |
| age, gender, | | |
| etc. | | |
| All collected | Identifies routes that are used by | Analyzes how all of |
| tracks | all participants; enables analyzing | the participants |
| | the carrying capacity of these | allocate their time. |
| | routes (for example, small alleys | |
| | and walkways in historic cities). | |

The points that have been collected using GPS include both stationary points and points sampled while the participant was moving. The points sampled when the person was not moving outdoors, for example, when he or she was sitting at a café or inside a store, are usually obtained in a certain radius of the point where he or she is actually located (for more information on GPS accuracy, see Shoval and Isaacson, 2006).

Calculating accurate information regarding the movement of the participants requires us to filter the points that do not describe movement. Filtering these points allows us to achieve two main goals. The first is the attainment of a general understanding of the participants' basic spatial behavior. How much time did the person spend at home? How much time did he or she spend at other destinations, such as in a shopping mall or a medical clinic?

The second goal is the calculation of parameters that describe the participant's movement. How fast did he or she walk? What distance does the participant walk every day? When does the participant choose to use a car? Not filtering these stationary points will result in including as movement the shifting points that are recorded when the person is stationary. A person who stays home all day will seem to be very active walking around the area in which he or she is sitting.

One way to analyze the participant's movement is by filtering the stationary points and classifying all of the points collected as belonging to either “nodes” or “tracks.” This distinction is central and has molded the way the data is treated in this project; many of the strengths and limitations result from it. Nodes are series of points that describe a time when the participant was stationary. Tracks are a series of connected points that describe movement. When examining tracks, it is possible to calculate the speed of movement and possibly the mode of transportation. In the data set, each track is defined by having two nodes, one at either end. The transition between nodes is by movement through a track.

The process explained above can be very time-consuming if done manually and therefore can benefit greatly by automatic processing. Dedicated automated processing software was developed in the framework of the SenTra project.

### Methods

### Research Design and Sample

Participants were recruited from outpatient referrals to the psycho-geriatric clinic at the Tel-Aviv Sourasky Medical Center. All participants were given a full explanation of the study, its purpose, and their role. They were also asked to identify a study partner, generally a family member, who currently cares for them, or would care for them if necessary. Half of the study partners were spouses, and half were other family members (all but one were adult children of the participants). All of the spouses resided with the participants, while only one of the other relatives did so. Living alone was associated with diagnosis, with only 18% of healthy controls living alone, compared with 28% of patients with Mild Cognitive Impairment (MCI) and 43% of those with mild dementia.

Only participants who consented to participate and who had a study partner who consented to participate took part in the study. Participants could withdraw from the study at any point in time if they did not wish to continue their participation. The project was approved by the hospital's IRB (“Helsinki Committee”) and registered with the NIH (number NCT00743418).

Participants underwent in-depth, multi-disciplinary diagnostic screening in order to determine their level of cognitive impairment (for a detailed explanation of this assessment, see Shoval et al., 2008). Following the meeting at the psycho-geriatric clinic, a second interview with the participant and his or her study partner was scheduled at the participant's home. Interviewers were licensed social workers, trained specially for this project. The participant interview included background information on the participant, information on basic housing conditions, functional health, social network, social support, emotional well-being, perceived functional independence, and indoor-outdoor motivation. Furthermore, the participant was presented with an extensive list of activities and services and was asked to indicate which of these he or she took part in or used. The study partner also completed similar instruments. The study partner was asked whether the participant tended to go out alone or whether someone else usually accompanied him or her. Following four weeks of GPS tracking both the participant and the study partner were interviewed again using similar instruments.

It is important to note that the analysis in this article is the product of a small sample of participants. Thus, analyses are based on descriptive statistics. At a later point in the future, when a larger sample is available, we will be able to see if the trends presented here are upheld when using statistical models.

Participants with cognitive impairment were older than healthy controls; and healthy participants had significant access to a car, however, there was no significant difference by gender (see table 2).

TABLE 2
The three groups of participants by gender, access to a car and age

| | Healthy | MCI | Mild Dementia |
|---|---|---|---|
| | N (%) | N (%) | N (%) |
| Gender | | | |
| Male (N = 25) | 7 (41) | 14 (56) | 4 (57.1) |
| Female (N = 24) | 10 (59) | 11 (44) | 3 (42.8) |
| Access to a car | | | |
| Yes (N = 27) | 13 (76) | 11 (44) | 3 (57.1) |
| No (N = 22) | 4 (24) | 14 (56) | 4 (42.8) |
| Age | | | |
| 64-76 years (N = 24) | 14 (82) | 9 (36) | 1 (14.2) |
| 77-90 years (N = 25) | 3 (18) | 16 (64) | 6 (85.7) |
| Total | 17 (100.0) | 25 (100.0) | 7 (100.0) |

### Assessment of Out-of-Home Mobility

The GPS tracking kit used in this study (obtained from HomeFree Wireless TelehomeCare Solutions, Tel-Aviv, Israel) consists of three main elements: 1) a portable unit that weights 400 grams, which contains a GPS receiver, GSM modem, and RF receiver; 2) a water-resistant wristwatch that includes a radio frequency (RF) transmitter and additional sensors, including one that detects whether the watch is being worn on a person's body; 3) a stationary home unit that repeats the RF signal and allows the participant to walk freely around the house (for a picture of the kit, see Shoval et al., 2008).

The “wristwatch” RF transmitter informs the researchers whether participants are complying with the research participation guidelines and can confirm whether they are carrying the GPS device at any given moment. If the strap is open or the RF transmitter is not in contact with the body, the system issues a notification. If the watch is worn on the hand, but is further than 10 meters from the GPS receiver (at home this maximum distance is 70 meters because of the home monitoring unit) then a notification is also issued. These notifications allow the researchers to determine whether the research subject is participating at a satisfactory level.

An invalid hour is considered when one of the following is happening for a consecutive period that is longer than 30 minutes: The “wristwatch” was taken off the hand by the participant, or the GPS was not functioning due to a battery that was not charged by the participant, or the “wristwatch” was out of the GPS range i.e. the participant left the GPS at one place and went to another place with the “wristwatch” on his hand but without the GPS device. A “valid day” is a day completed with not even one hour missing.

Aggregating these data allows for measuring the overall level of compliance and, as a result, assessing the quality of the data obtained during the relatively long tracking period (Shoval et al., 2008). This enabled us to assess the degree to which the collected data could really be interpreted as a representation of the participants' spatial behavior.

The GPS receiver was programmed to obtain locations every 10 seconds. It had the ability to function for approximately 12 hours without recharging. This feature is an essential one, as some participants leave their homes for long periods of time during the day. The data collected were transferred by GPRS (General Packet Radio Service) to the project's server at the Hebrew University of Jerusalem. This enabled the researchers to monitor the tracking kits in real-time in order ascertain that the kits were functioning and had sufficient battery power and that the subjects were following the study's guidelines.

### Results

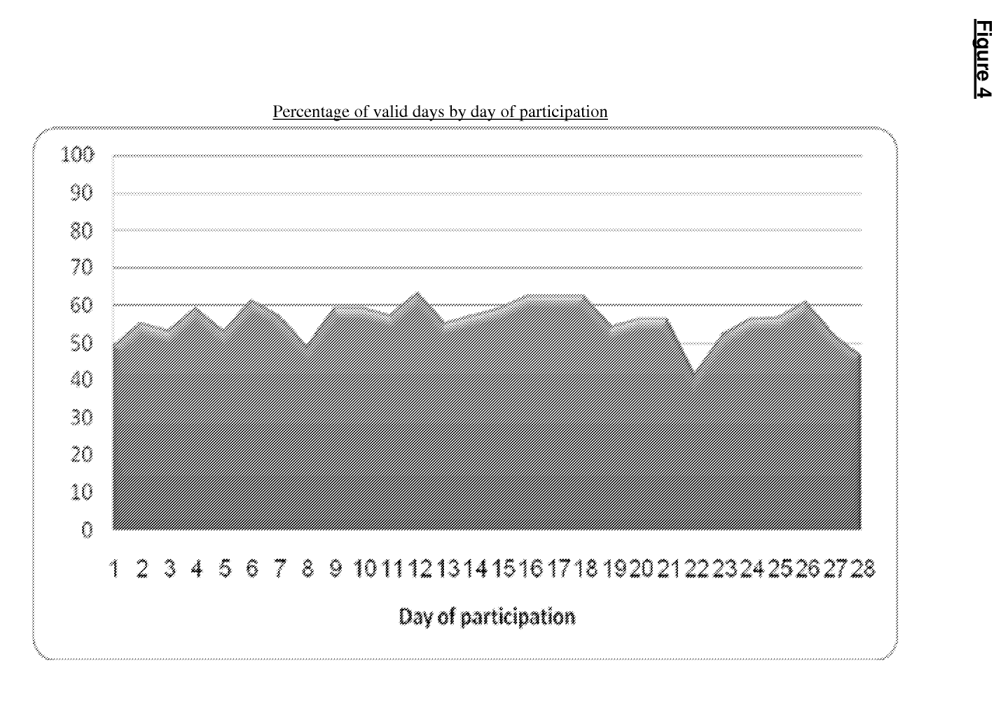

Forty-nine elderly participants from three cognitive groups were tracked for an average of 28.2 days or 676.9 hours. The participants had an average of 90.4% of valid hours and an average 15.6 days that were fully valid, i.e., completed with not even one hour missing. All participants had similar percentages of valid hours, but those with no cognitive impairments had slightly higher rates of valid days [see FIG. 3].

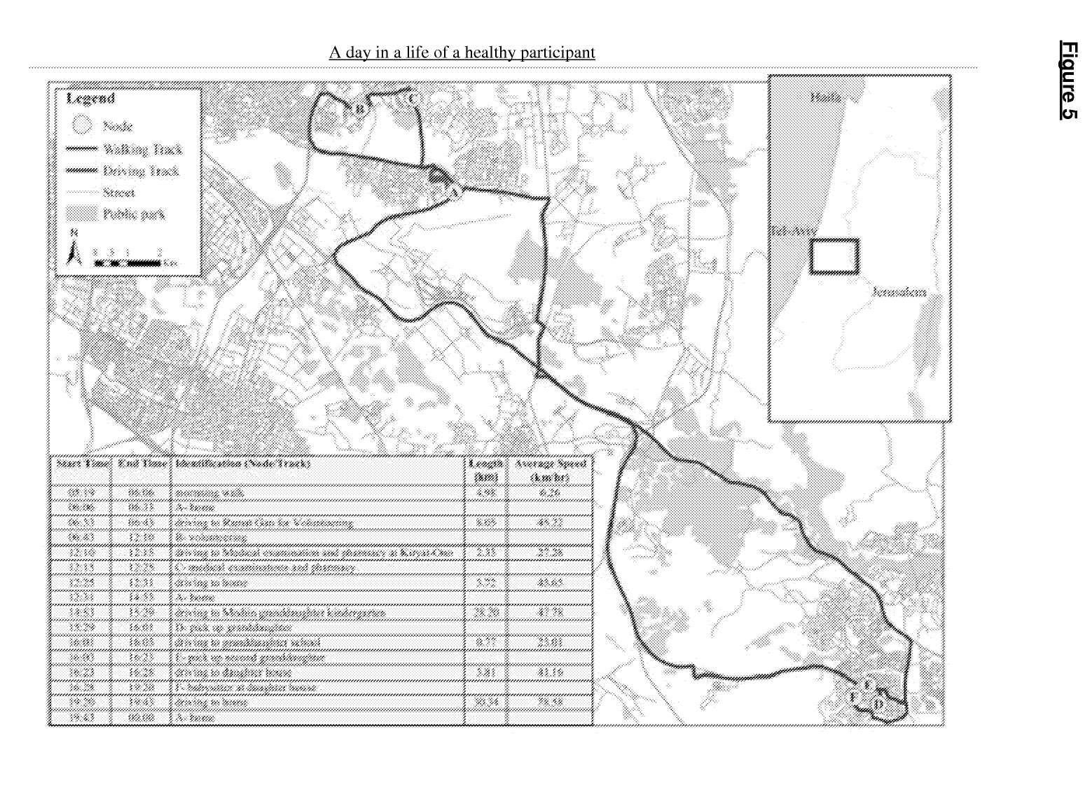

FIG. 4 presents the percentage of valid days throughout the tracking period. It is evident and rather surprising that there is hardly any ‘participation fatigue’ amongst the participants, though we would have expected to find a decline in the level of participation over time, as a natural result of the burden of participation. However, the findings are in line with results of previous long term data collection research designs (Hanson, 1977; Axhausen et al., 2002).

### Analysis of Movement on the Individual and Aggregative Levels

First we will use the activity of individual participants from the SenTra study to present new types of data that are available as a result of the highly detailed data collected by GPS devices that are both spatially accurate (meters) and temporally frequent (seconds). In the second part of this section we will present aggregated results regarding various elements of the time-space activities of all the participants. As discussed above, these analyses are challenging due to the computational and analytical burden created by the large amounts of data collected. All of our analysis is the result of the conceptual framework that divides all the obtained locations to either belong to movement event (“tracks”) or to a stationary activity in a place (“nodes”) and a series of semi-automatic processes that enable us to deal with the large amounts of data.

### Individual Level

### Example 1

### A Day in a Life of an Elderly Person

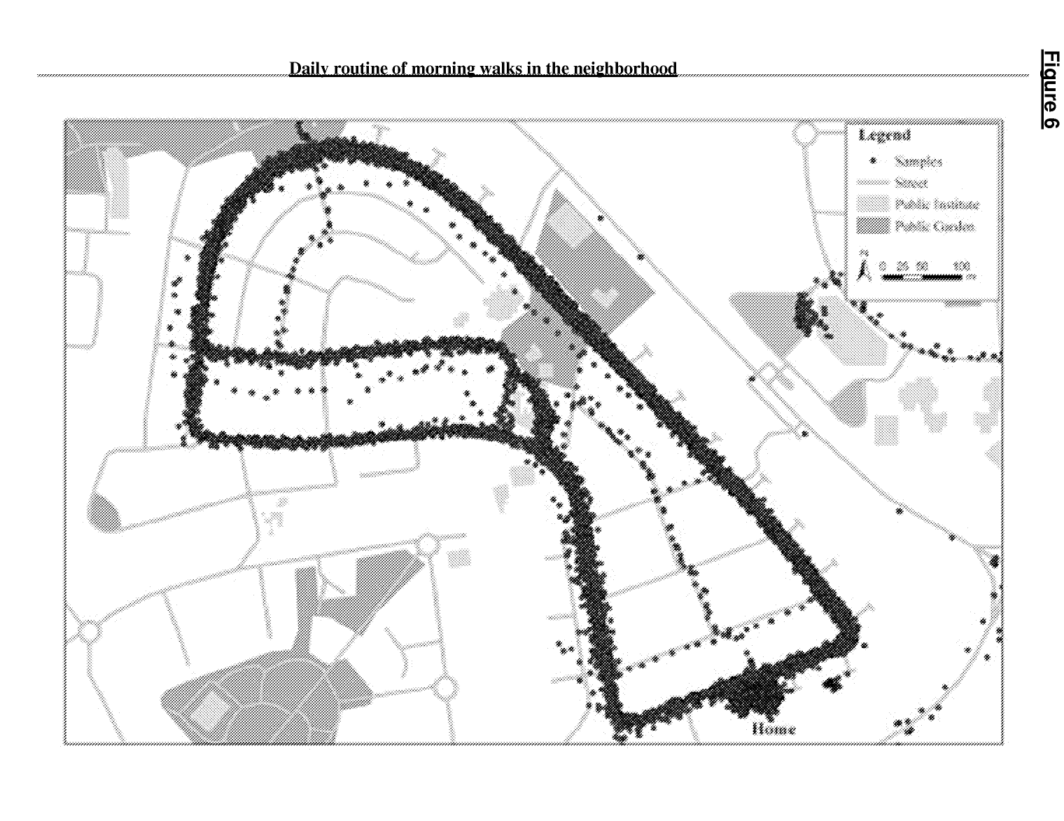

Participant 109 is a healthy male, 67 years old that owns a car and drives it. He was tracked for 28 days; 21 of them were valid (i.e. with no geographic data missing). FIG. 5 presents the participant's spatial activity for one day. The table at the lower left side of the figure presents detailed information detailing both with the physical characteristics of the participant's spatial activity as well as the purpose of each movement. Detailed information as to the motives behind spatial activity was obtained using the in-depth interviews during and at the end of the participation.

### Example 2

### Daily Morning Walk in the Neighborhood

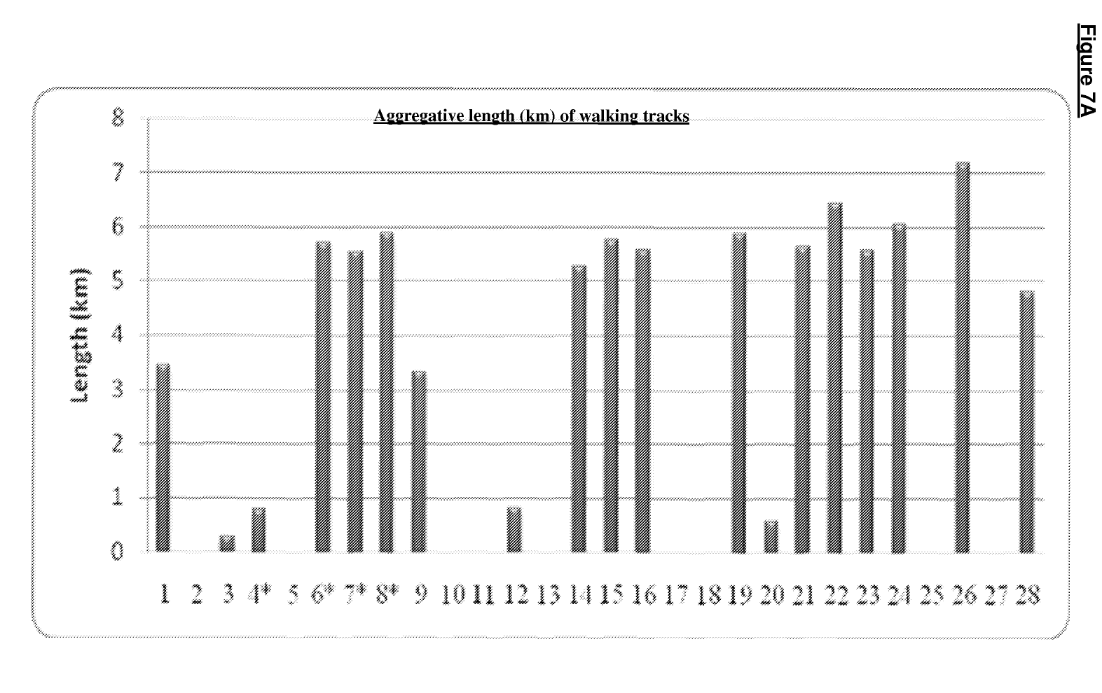

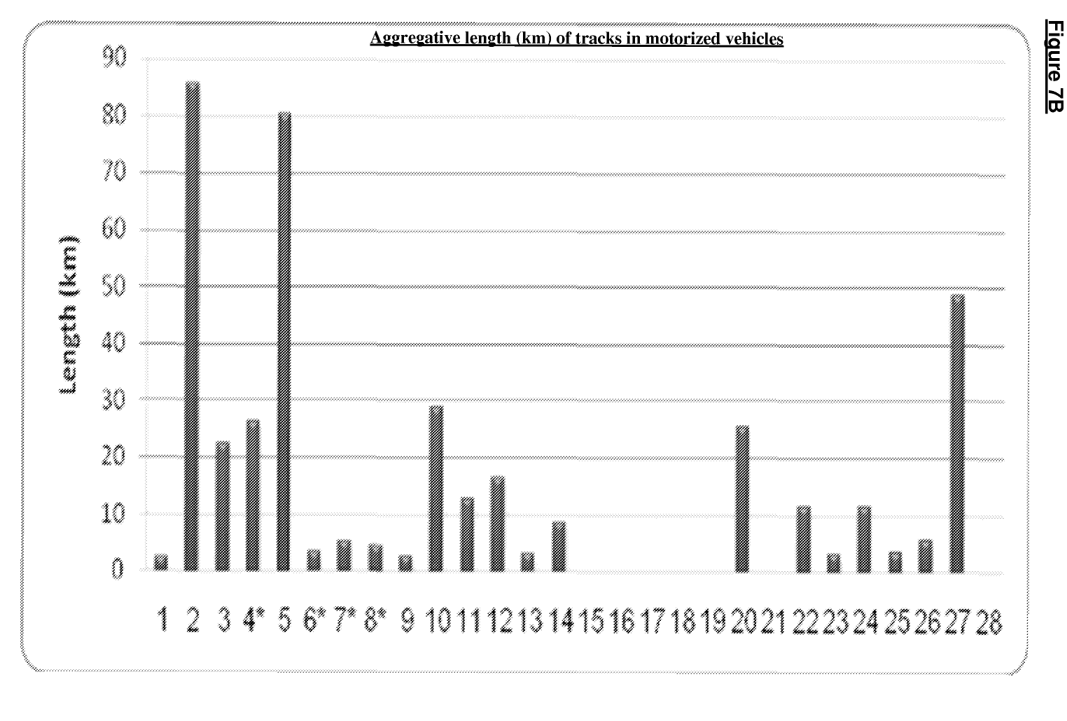

FIG. 6 presents all the walking tracks of the same participant that appeared in example 1 in the vicinity of his home during a period of 28 consecutive days. There are a total of 52,090 points presented in this map; this emphasizes the importance of the initial processing of the raw data. Each point presents a location that was obtained by the GPS receiver while the participant was located within the map's extent. It is clear that without an analytical framework there is not much information that we can obtain from the raw data.

Table 3 demonstrates the highly detailed information that we are able to derive from these GPS samples. Other parameters describing the walk can be calculated as well, such as the degree of variation in the walking speed, etc. It is apparent that the participant has a very rigid daily routine of an early morning walk that starts sometime between 05:30-06:30, for duration of 45 minutes, an average speed of 6.24 kilometers per hour that results in an average morning walk of 4.78 kilometers.

TABLE 3
Walking tracks of participant 109 during 28 days
in the vicinity of his home

| | Duration | Length | Speed | | |
|---|---|---|---|---|---|
| Track ID | (min) | (km) | (kmph) | Time | weekday |
| 1005 | 12.07 | 1.04 | 5.16 | 30/04/2009 17:20 | 5 |
| 1006 | 46.40 | 4.73 | 6.11 | 01/05/2009 06:14 | 6 |
| 1013 | 51.23 | 4.89 | 5.72 | 02/05/2009 06:12 | 7 |
| 1014 | 45.13 | 4.86 | 6.46 | 03/05/2009 05:23 | 1 |
| 1024 | 54.45 | 5.55 | 6.12 | 04/05/2009 05:49 | 2 |
| 1025 | 43.13 | 4.69 | 6.53 | 05/05/2009 06:14 | 3 |
| 1033 | 44.67 | 4.65 | 6.25 | 06/05/2009 05:28 | 4 |
| 1036 | 45.62 | 4.75 | 6.24 | 07/05/2009 06:47 | 5 |
| 1037 | 50.53 | 5.11 | 6.07 | 08/05/2009 06:02 | 6 |
| 1038 | 23.22 | 2.33 | 6.02 | 09/05/2009 06:15 | 7 |
| 1043 | 42.53 | 4.67 | 6.59 | 10/05/2009 05:26 | 1 |
| 1050 | 47.53 | 5.30 | 6.69 | 11/05/2009 05:51 | 2 |
| 1053 | 47.43 | 4.95 | 6.27 | 12/05/2009 06:27 | 3 |
| 1061 | 43.98 | 4.55 | 6.21 | 14/05/2009 06:04 | 5 |
| 1062 | 52.12 | 5.13 | 5.90 | 15/05/2009 05:53 | 6 |
| 1063 | 48.07 | 5.00 | 6.25 | 16/05/2009 06:18 | 7 |
| 1064 | 47.40 | 4.86 | 6.16 | 17/05/2009 05:18 | 1 |
| 1068 | 46.93 | 4.93 | 6.30 | 18/05/2009 05:25 | 2 |
| 1073 | 48.15 | 4.98 | 6.21 | 19/05/2009 05:23 | 3 |
| 1081 | 47.78 | 5.01 | 6.29 | 20/05/2009 05:25 | 4 |
| 1089 | 49.65 | 5.04 | 6.09 | 21/05/2009 05:37 | 5 |
| 1098 | 48.47 | 5.00 | 6.19 | 22/05/2009 06:18 | 6 |
| 1104 | 42.28 | 4.37 | 6.20 | 23/05/2009 05:59 | 7 |
| 1107 | 43.07 | 4.57 | 6.36 | 24/05/2009 05:27 | 1 |
| 1110 | 42.35 | 4.38 | 6.20 | 25/05/2009 05:54 | 2 |
| 1111 | 42.20 | 4.62 | 6.56 | 26/05/2009 06:06 | 3 |
| 1114 | 47.70 | 4.98 | 6.26 | 27/05/2009 05:19 | 4 |
| 1123 | 51.00 | 5.19 | 6.11 | 28/05/2009 05:57 | 5 |
| Average | 44.83 | 4.78 | 6.24 | | |

### Example 3

### Aggregative Data of Daily Walking and Driving Distance Over One Month

Participant 82 is a mildly demented male, 84 years old who has access to a car within his household, but which he personally does not drive anymore. This participant was tracked for 28 days, 24 of which were valid. FIG. 5 presents the participant's aggregated length of walking and driving tracks for each day. The differentiation between tracks of walking and driving was done on the basis of the average speed of each track, all tracks below 6 kilometers per hour were considered as walking and the rest of the tracks were considered as driving. Each track of this participant was analyzed manually in order to ensure that all the “walking” tracks are actually representing walking activity and not traffic congestion.

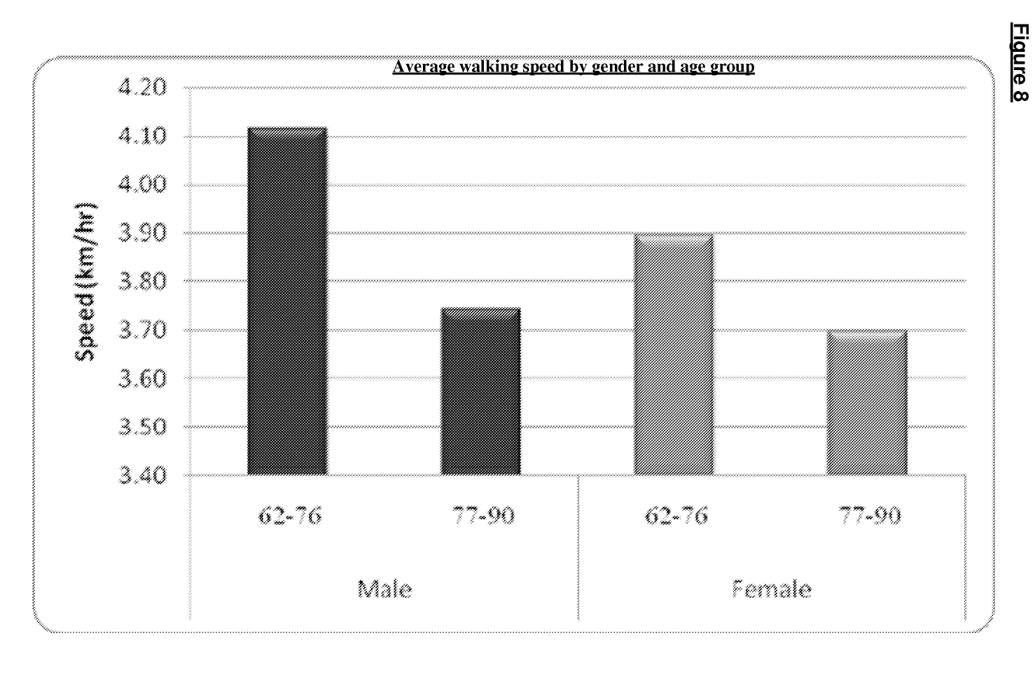

FIG. 7A presents the average walking distance per day. It can be observed that walking is not an activity that takes place every day; in fact Saturdays are usually days of almost no walking activity (days 4, 11, 18, 25). During about half of the days of the month tracked, the participant walked distances of about 5 to 6 kilometers.

FIG. 7B presents the average distance traveled in motorized vehicles (private or public). The patterns revealed in the figure show that this individual used motorized transportation for most of the days that he participated in the research (21 out of 28). The distances were usually in the range of 10-30 kilometers per day with three exceptions of significantly longer journeys.

### Appreciative Level

In this section we present some examples of aggregated analysis regarding various elements of movement in time and space for all the participants who are being considered in this article (n=49).

### Example 4

### Average Walking Speed by Gender and Age Group

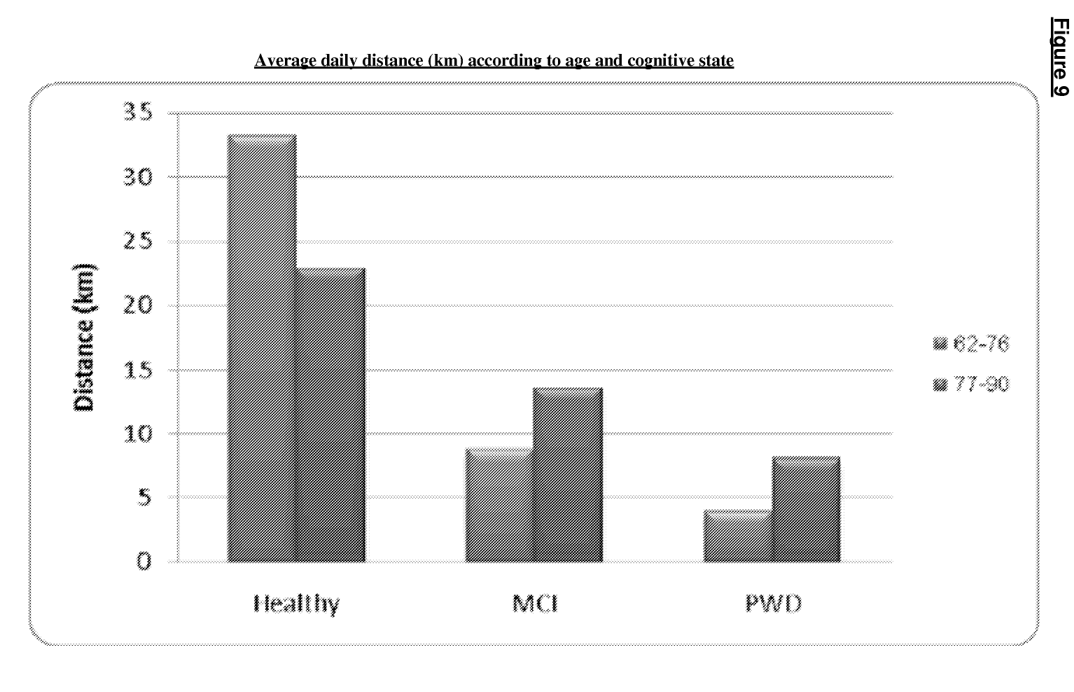

The high-resolution data obtained enable us to calculate the speed of every walking or motorized track with high precision and as a result to calculate the average walking speed of various subgroups. In this example we present the influence of gender and age on the speed of walking. It is clearly illustrated that males walk slightly faster than females; this may be explained by the difference in height and therefore difference in stride length. Age seems to also provide a clearly visible explanation of differences in average speed; as people age they walk at slower speeds. [see FIG. 8]

### Example 5

### Average Daily Distance (km) According to Age and Cognitive State

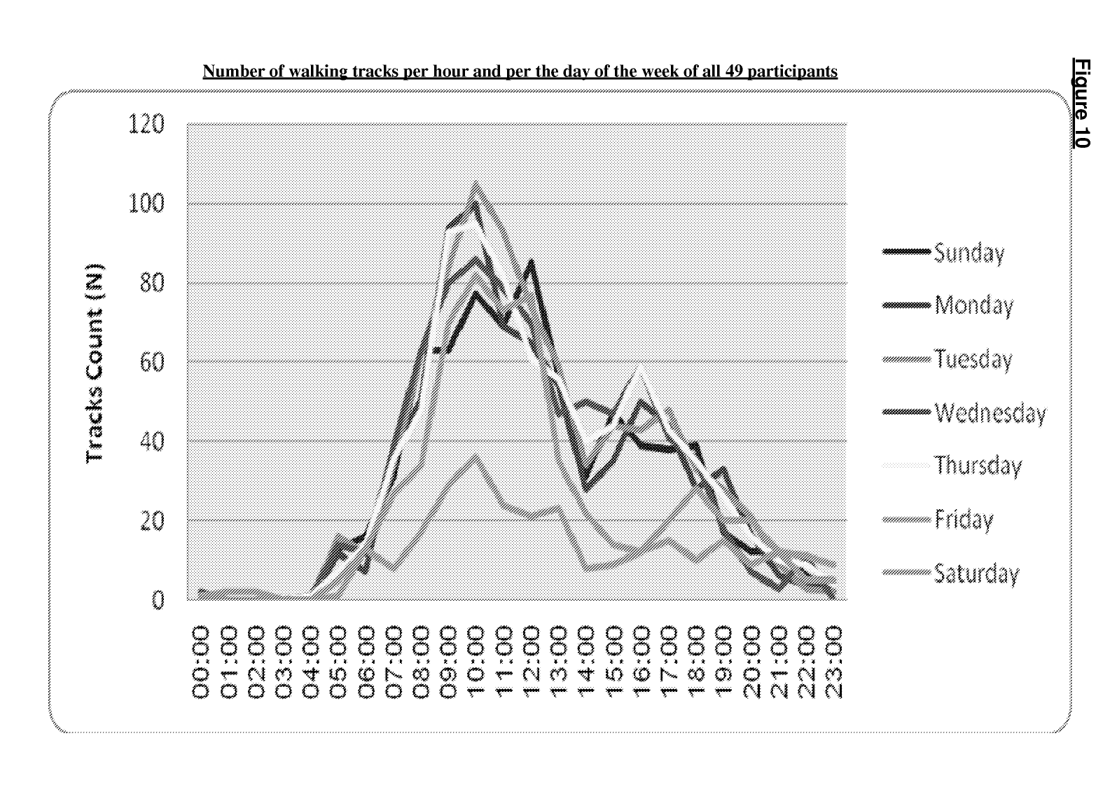

FIG. 9 presents the average distance travelled by elderly people in two age groups and with different cognitive abilities. The travelled distance is a measure that indicates the degree at which a person is able to partake in activities and gives an indication of the spatial freedom that a person experiences. Populations with limited average distance travelled have fewer opportunities to take part in activities and use services that are out of their range. Decline in cognitive abilities seems to have a clear influence on the decline of distance traveled. This may be due to loss of independence experienced by those with cognitive decline, because of the lack of confidence of the individual to navigate in space, or because of immediate family or caregiver's lack of confidence in the individual's abilities to independently navigate. Note that the range of activity actually increases for the more elderly with MCI and dementia; this is because of the assistance that these people receive in traveling to daycare centers in which they spend the majority of their day.

### Example 6

### When Tracks are Used as the Unit of Research

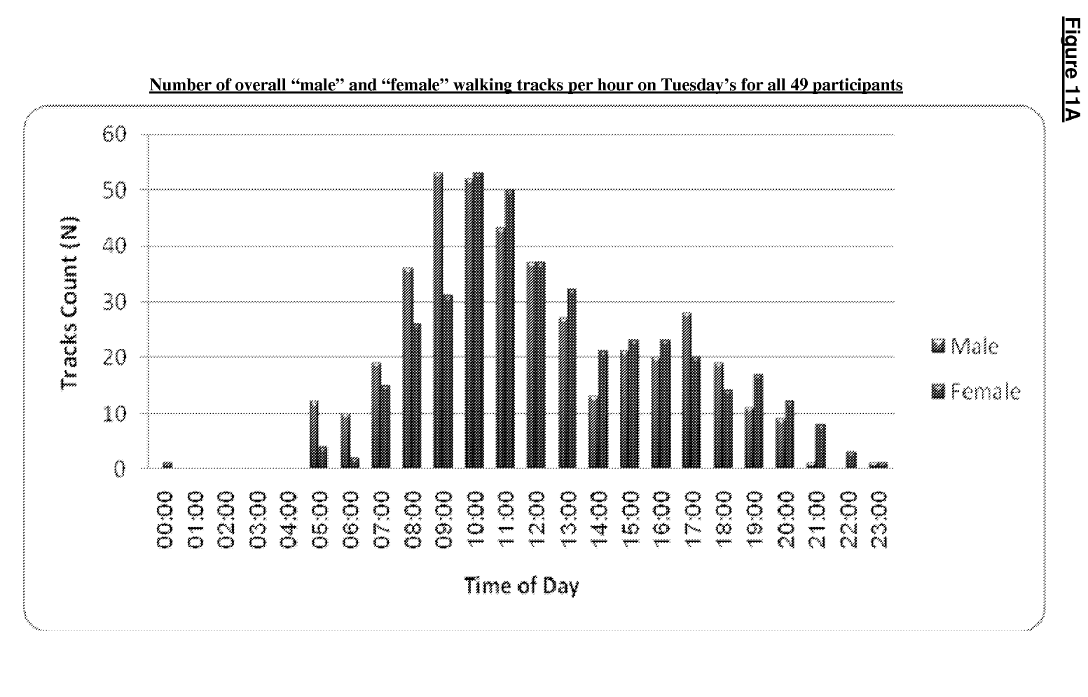

Another way to examine the data is by aggregating all the tracks (in this example all the walking tracks) and then by observing the general trends that emerge from the data. This point of view uses the number of tracks that a person generates as an indication of activity level. FIG. 10 presents the average number of walking tracks each day of the week and each hour of the day for all of the participants. Note the peak in movement in the late morning hours and the second lower peak in the afternoon. The days of the week also have different patterns, Saturday (the Jewish day of rest: Sabbath) is a day of rest in Israel, and all shops are closed. Friday starts with a similar pattern as the other weekdays, but towards the afternoon, when the Sabbath approaches, there is a significant decline in the average number of walking tracks.

Further analysis can add external variables such as the weather and the length of the day which changes during the year in order to see if different trends will be detected as a result of the seasons.

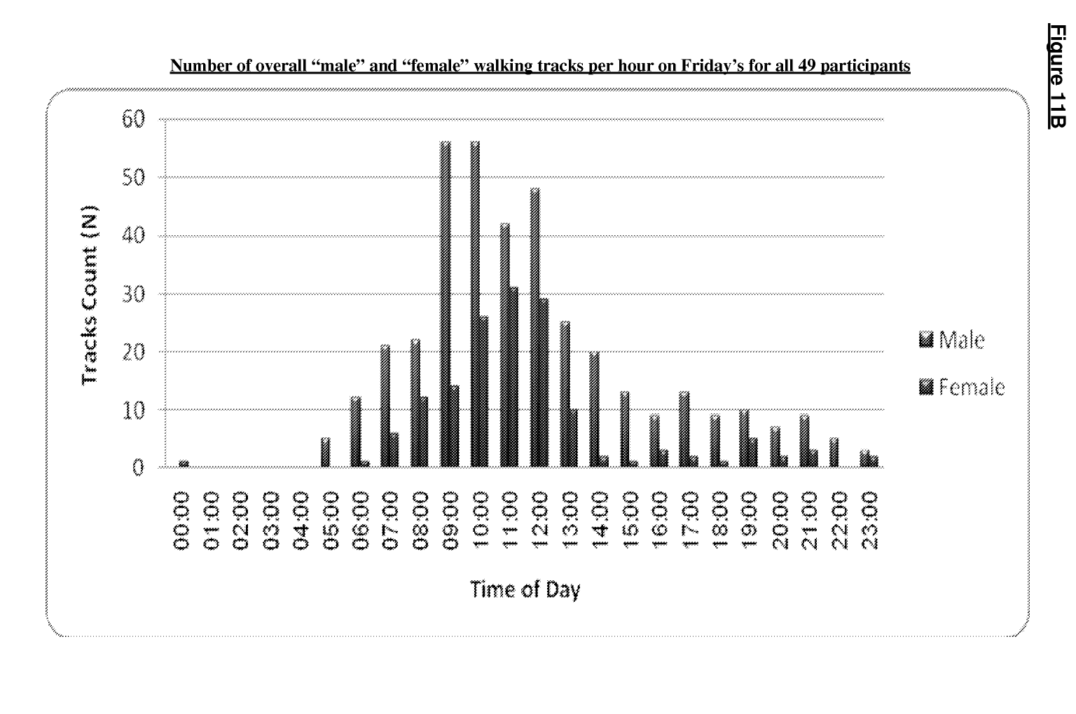

Adding gender as a variable to the previous analysis regarding the amount of walking tracks and regarding the different days of the week presents us with interesting differences between males and females [see FIGS. 11A-11B]. It is important to note that there is almost identical number of females (n=24) and males (n=25) in the sample (table 2). The similarity in the numbers means that the different patterns depicted in FIGS. 11A and 11B are not the result of the different number of males and females in the sample, but a result of their different patterns in time and space.

FIG. 11A depicts the number of overall “male” and “female” walking tracks during the hours of the day on Tuesdays. It is interesting that males are slightly more active outside their homes during the first half of the day while females are slightly more active outside their homes during the second part of the day. Currently we do not have a convincing explanation for this pattern and we will need to see if in the future, when the same analysis is done with a higher number of participants, whether this trend still holds.

However, a more visible difference in activity is seen in FIG. 11B regarding Fridays. It can be seen that males are more active outside their homes than females; we assume that this reflects their responsibility for shopping and other out of home household tasks that need to be done before the weekend while the female participants are probably busier with domestic tasks at home such as cooking and cleaning.

The Article, Shoval, Noam et al., “What can we team about the mobility of the elderly in the GPS era?” Journal of Transport Geography, Vol. 18, Issue 5 (September 2010), pgs. 603-612, is hereby incorporated into the present description in its entirety.

It should be understood that the above described exemplary embodiments are presented solely to exemplify the principles of the present invention, and by nature do not encompass the many possible implementations and embodiments of the present invention.

We claim:

1. A system for characterizing a subject's physical condition comprising:
a localization device adapted to be carried by the subject and to detect positioning information of the subject; and
a data processing unit adapted to derive one or more parameters relating to a subject's physical condition based on positioning information received from said localization device.

2. The system according to claim 1, further comprising a first biometric sensor.

3. The system according to claim 1, further comprising a storage device adapted to be carried by the subject and to store said positioning information.

4. The system according to claim 1, wherein said localization unit is adapted to perform said detection periodically.

5. The system according to claim 1, wherein said localization unit is adapted to perform said detection substantially continuously.

6. The system according to claim 1, wherein said data processing unit receives said positioning information from said localization device substantially continuously.

7. The system according to claim 1, wherein said processing unit receives said positioning information from said localization device via wireless communication.

8. The system according to claim 1, further comprising a storage device adapted to receive said positioning information from said localization device and to send said positioning information to said data processing unit.

9. The system according to claim 1, wherein said information received from said localization device includes at least one point the subject was located at; and wherein said processing unit is further adapted to determine whether at least one of said points is located in a node or on a track.

10. The system according to claim 1, wherein at least one of said derived parameters is a parameter selected from the group of parameters consisting of:
a. distance walked by the subject;
b. walking pace of the subject;
c. frequency of stops by the subject, when moving;
d. frequency of trips made by the subject to a restroom;
e. frequency the subject performs a specific physical activity;
f. physical activity level of the subject correlated to hours of the day;
g. longest time spent by the subject sitting continuously;
h. longest time spent by the subject standing continuously; and
i. locations visited frequently by the subject.

11. The system according to claim 1, wherein said parameters relate to said subject's medical condition.

12. The system according to claim 1, wherein said subject is a patient selected from the group of patients consisting of:
a. patients with an Orthopedic condition;
b. patients with a Cardiovascular condition;
c. patients with joint pathologies;
d. patients with a neurodegenerative condition;
e. patients with a traumatic condition; and
f. patients with a metabolic condition.

13. The system according to claim 1, wherein said data processing unit is further adapted to derive parameters relating to said subject according to a medical index.

14. The system according to claim 13, wherein said medical index is the claudication index.

15. A method of characterizing a subject's physical condition comprising:
recording positional data related to a subject by use of a localization device adapted to be carried by the subject; and
deriving parameters relating to the subject's physical condition from said positional data.

16. The method according to claim 15, further comprising recording biometric data related to said subject.

17. The method according to claim 15, further comprising storing said positional data on a storage device adapted to be carried by the subject.

18. The method according to claim 15, wherein said recording is performed periodically.

19. The method according to claim 15, wherein said recording is performed substantially continuously.

20. The method according to claim 15, further comprising sending said positional data from said localization device to a data processing unit adapted to derive said parameters.

21. The method according to claim 16, wherein said sending of said positioning information from said localization device is performed substantially continuously.

22. The method according to claim 16, wherein said sending of said positioning information from said localization device is performed by wireless means.

23. The method according to claim 15, further comprising receiving said positioning information from said localization device by a storage device; and
sending said positioning information from said storage device to said data processing unit.

24. The method according to claim 15, further comprising determining at least one point the subject was positioned in is located in a node or on a track.

25. The method according to claim 15, wherein at least one of said derived parameters is a parameter selected from the group of parameters consisting of:
a. distance walked by the subject;
b. walking pace of the subject;
c. frequency of stops by the subject, when moving;
d. frequency of trips made by the subject to a restroom;
e. frequency the subject performs a specific physical activity;
f. physical activity level of the subject correlated to hours of the day;
g. longest time spent by the subject sitting continuously;
h. longest time spent by the subject standing continuously; and
i. locations visited frequently by the subject.

26. The method according to claim 15, wherein said derived parameters relate to the subject's medical condition.

27. The method according to claim 15, wherein said subject is a patient selected from the group of patients consisting of:
a. patients with an Orthopedic condition;
b. patients with a Cardiovascular condition;
c. patients with joint pathologies;
d. patients with a neurodegenerative condition;
e. patients with a traumatic condition; and
f. patients with a metabolic condition.

28. The method according to claim 15, further comprising deriving parameters relating to said subject according to a medical index.

29. The method according to claim 28, wherein said medical index is the claudication index.
